(19) United States
(12) Patent Application Publication
(10) Pub. No.: US 2026/0339892 A1
(43) Pub. Date: Oct. 29, 2026

(54) METHOD FOR ACQUIRING THUMBNAILS FOR DUPLICATE FILES PRESENT IN SOURCE DEVICES, AND SINK DEVICE USING SAME

(71) Applicant: SAMSUNG ELECTRONICS CO., LTD., Suwon-si (KR)

(72) Inventors: Kihoon KIM, Suwon-si (KR); Chihyun CHO, Suwon-si (KR); Minseok KIM, Suwon-si (KR); Younggi KIM, Suwon-si (KR); Kyeonghun LEE, Suwon-si (KR); Younghyun JOO, Suwon-si (KR)

(73) Assignee: SAMSUNG ELECTRONICS CO., LTD., Suwon-si (KR)

(21) Appl. No.: 19/699,782

(22) Filed: Jun. 5, 2026

Related U.S. Application Data
(63) Continuation of application No. PCT/KR2024/006776, filed on May 20, 2024.

(30) Foreign Application Priority Data
Dec. 6, 2023 (KR) 10-2023-0175931

(51) Int. Cl. G06F 16/14; G06F 16/48

(52) U.S. Cl. CPC G06F 16/148; G06F 16/48

(57) ABSTRACT

A method performed by a sink device, and a sink device performing the method, are provided. The method includes receiving, from each source device of a plurality of source devices, metadata of multimedia files stored in the source device and system resource information of the source device, detecting the plurality of duplicate files among the multimedia files stored in each source device based on the metadata, determining, for each source device, an allocated number of duplicate files to be requested from the source device based on the system resource information of the source device, and obtaining a plurality of thumbnails corresponding to a plurality of duplicate files by requesting, from each source device, one or more duplicate files of the plurality of duplicate files or one or more thumbnails of the plurality of thumbnails corresponding to the allocated number of duplicate files.

### CROSS-REFERENCE TO RELATED APPLICATIONS

This application is a bypass continuation application of International Application No. PCT/KR2024/006776, filed on May 20, 2024, which claims priority to Korean Patent Application No. 10-2023-0175931, filed on Dec. 6, 2023, in the Korean Intellectual Property Office, the disclosures of which are incorporated by reference herein in their entireties.

### BACKGROUND

### 1. Field

The present disclosure relates to a sink device and source devices. More specifically, the present disclosure relates to a method by which a sink device obtains thumbnails for duplicate files present in source devices.

### 2. Description of Related Art

A technology for connecting a source device to a sink device and displaying files present in the source device on the sink device has been utilized. For example, a TV displays videos or images received from a smartphone.

When duplicate files are in source devices, it is inefficient for the sink device to receive duplicate files from all the source devices. Similarly, when there are duplicate files in the source devices, it is inefficient for the sink device to receive thumbnails of the duplicate files from all the source devices.

### SUMMARY

According to an aspect of the disclosure, a method performed by a sink device for obtaining a plurality of thumbnails corresponding to a plurality of duplicate files stored in a plurality of source devices may be provided. The method may include receiving, from each source device of the plurality of source devices, metadata of multimedia files stored in the source device and system resource information of the source device, detecting, for each source device of the plurality of source devices, the plurality of duplicate files among the multimedia files stored in the source device based on the metadata, determining, for each source device of the plurality of source devices, an allocated number of duplicate files to be requested from the source device based on the system resource information of the source device, and obtaining the plurality of thumbnails by requesting, from each source device of the plurality of source devices, one or more duplicate files of the plurality of duplicate files or one or more thumbnails of the plurality of thumbnails corresponding to the allocated number of duplicate files.

According to an aspect of the disclosure, a sink device for obtaining a plurality of thumbnails corresponding to a plurality of duplicate files stored in a plurality of source devices may be provided. The sink device may include memory storing one or more instructions and one or more processors configured to execute the one or more instructions. The one or more instructions, when executed by the one or more processors individually or collectively, may cause the sink device to receive, from each source device of the plurality of source devices, metadata of multimedia files stored in the source device and system resource information of the source device, detect, for each source device of the plurality of source devices, the plurality of duplicate files among the multimedia files stored in the source device based on the metadata of the multimedia files of the source device, determine, for each source device of the plurality of source devices, an allocated number of the duplicate files to be requested from the source device based on the system resource information of the source device, and obtain the plurality of thumbnails by requesting, from each source device of the plurality of source devices, one or more duplicate files of the plurality of duplicate files or one or more thumbnails of the plurality of thumbnails corresponding to the allocated number of duplicate files.

According to an aspect of the disclosure, a non-transitory computer-readable recording medium having recorded thereon a program for causing a sink device to perform the method may be provided.

The above summary is provided to introduce a selection of concepts, in a simplified format, that are further described in the detailed description of the disclosure. This summary is neither intended to identify key or essential inventive concepts of the disclosure, nor is it intended to determine the scope of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a sink device and source devices, according to an embodiment;

FIG. 2A is a diagram illustrating a duplicate check module of a sink device, according to an embodiment;

FIG. 2B is a diagram illustrating a monitoring module of a sink device, according to an embodiment;

FIG. 2C is a diagram illustrating a scheduling module of a sink device, according to an embodiment;

FIGS. 3A-3C are diagrams illustrating scenarios in which a sink device obtains thumbnails, according to embodiments;

FIG. 4 is a diagram illustrating a scheduling module and a generation module of a sink device, according to an embodiment;

FIG. 5 is a diagram illustrating a scenario in which a sink device obtains thumbnails, according to an embodiment;

FIGS. 6 and 7 are flowcharts of a method by which a sink device obtains thumbnails for duplicate files present in source devices, according to embodiments.

FIG. 8 is a flowchart of a method by which a sink device obtains duplicate files present in source devices, according to an embodiment; and

FIGS. 9A and 9B are block diagrams of a sink device according to an embodiment.

### DETAILED DESCRIPTION

The terms used in this specification will be briefly explained, and the present disclosure will be described in detail. In the present disclosure, the expression "at least one of a, b or c" may refer to " a", " b", " c", "a and b", "a and c", "b and c", "all of a, b, and c", or variations thereof.

The terms used in the present disclosure are selected from commonly used terms as much as possible while considering the functions of the present disclosure, but these may vary depending on the intention of engineers working in the field, precedents, the emergence of new technologies, etc. Additionally, in certain cases, there are terms arbitrarily selected by the applicant, and in these cases, their meanings will be described in detail in the relevant description. Therefore, the terms used in the present disclosure should be defined based on the meaning of the terms and the overall details of the present disclosure, rather than simply the names of the terms.

Singular expressions may include plural expressions unless the context clearly indicates otherwise. Terms used herein, including technical or scientific terms, have the same meaning as commonly understood by one of ordinary skill in the art described herein. Terms including ordinal numbers, such as ʺfirstʺ or ʺsecond,ʺ used in the present disclosure may be used to describe various components, but the components should not be limited by the terms. The terms are used solely to distinguish one component from another.

When it is said throughout the specification that a part "includes" a certain component, this does not exclude other components, but rather may include other components, unless specifically stated otherwise. In the specification, the terms "unit", "module" etc., indicate a unit that processes at least one function or operation, which may be implemented by hardware or software, or by a combination of hardware and software.

It should be understood that each embodiment described herein may be applied to one or more other embodiments.

In the present disclosure, a "multimedia file" may indicate any file that may include various media elements other than text. For example, a multimedia file may include an image file, a video file, an audio file, and a document file. For example, an image file format may include JPEG, PNG, GIF, TIFF, and BMP; a video file format may include MP4, MOV, WMV, AVI, and FLV; an audio file format may include WAV, FLAC, M4A, AAC, MP3, and WAV; and a document file format may include PDF, PPT, PPTX, DOC, and DOCX, but are not limited to the examples listed.

In the present disclosure, a "sink device" may indicate an electronic device that receives a multimedia file from a source device in a relationship with the source device.

In the present disclosure, a "source device" may indicate an electronic device that transmits a multimedia file to a sink device in a relationship with the sink device.

In the present disclosure, a "duplicate file" may indicate a multimedia file that is stored in duplicate on two or more source devices.

In the present disclosure, a "thumbnail" may indicate an indicator representing a multimedia file.

In the present disclosure, an "original file" may indicate a multimedia file from which a thumbnail is generated.

Below, with reference to the attached drawings, embodiments of the present disclosure are described in detail so that one of ordinary skill in the art may easily implement the present disclosure. However, the present disclosure may be implemented in many different forms and is not limited to the embodiments described herein.

The present disclosure will be described in detail with reference to the attached drawings below.

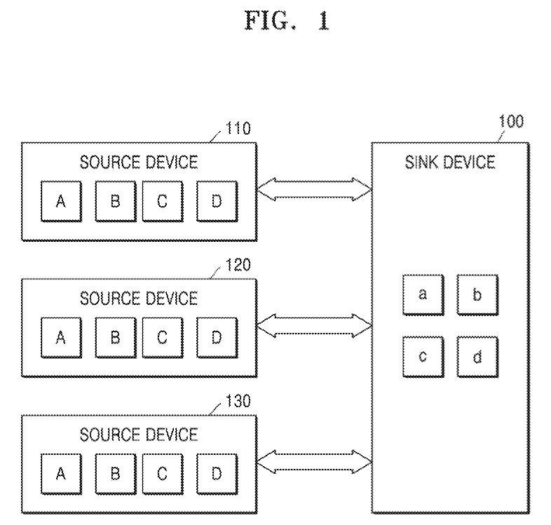

FIG. 1 is a diagram illustrating a sink device 100 and source devices 110, 120, and 130 according to an embodiment.

The sink device 100 may be an electronic device that receives multimedia files from the source devices 110, 120, and 130 in a relationship with the source devices 110, 120, and 130. For example, the sink device 100 may include at least one of a television, a smart TV, a monitor, a smart monitor, a digital signage, a projector, a smart phone, a wearable device, a tablet, a laptop, or a personal computer (PC), but is not limited to the examples listed.

The source devices 110, 120, and 130 may be electronic devices that transmit multimedia files to the sink device 100 in a relationship with the sink device 100. For example, each of the source devices 110, 120, and 130 may include at least one of a camera, a smart phone, a wearable device, a tablet, a laptop, or a PC, but is not limited to the examples listed.

One or more source devices 110, 120, and 130 may be connected to the sink device 100. According to an embodiment, FIG. 1 illustrates the sink device 100 connected to three source devices 110, 120, and 130.

The sink device 100 may communicate with the source devices 110, 120, and 130. The sink device 100 may communicate with the source devices 110, 120, and 130 via wireless communication or wired communication.

According to an embodiment, FIG. 1 illustrates the source devices 110, 120, and 130 storing multimedia files A, B, C, D and the sink device 100 that obtains thumbnails a, b, c, d of the multimedia files.

Additionally, in an embodiment, a first thumbnail a is a thumbnail of a first multimedia file A, a second thumbnail b is a thumbnail of a second multimedia file B, a third thumbnail c is a thumbnail of a third multimedia file C, and a fourth thumbnail d is a thumbnail of a fourth multimedia file D.

The sink device 100 may obtain the thumbnails a, b, c, d by requesting the thumbnails a, b, c, d from the source devices 110, 120, and 130.

Alternatively, the sink device 100 may obtain the thumbnails a, b, c, d by requesting the multimedia files A, B, C, D from the source devices 110, 120, and 130 and generating the thumbnails a, b, c, d by using the multimedia files A, B, C, D received from the source devices 110, 120, and 130.

The sink device 100 may display the obtained thumbnails a, b, c, d. Additionally, the sink device 100 may display the obtained multimedia files A, B, C, D.

In an embodiment, the first to third source devices 110, 120, and 130 store the multimedia files A, B, C, D in common in duplicate. That is, the multimedia files A, B, C, D are duplicate files.

As there are a plurality of source devices 110, 120, and 130 storing the duplicate files A, B, C, D, there are a plurality of schemes for the sink device 100 to obtain the thumbnails a, b, c, d. For example, the sink device 100 may obtain the thumbnails a, b, c, d by requesting the first and second duplicate files A, B or the first and second thumbnails a, b from the first source device 110, requesting the third duplicate file C or the third thumbnail c from the second source device 120, and requesting the fourth multimedia file D or the fourth thumbnail d from the third source device 130. Alternatively, the sink device 100 may obtain the thumbnails a, b, c, d by requesting the first duplicate file A or the first thumbnail a from the first source device 110, requesting the second and third duplicate files B, C or the second and third thumbnails b, c from the second source device 120, and requesting the fourth multimedia file D or the fourth thumbnail d from the third source device 130.

In order for the sink device 100 to efficiently obtain thumbnails of duplicate files, it has to be determined from which source device among the source devices 110, 120, and 130 thumbnails of how many duplicate files are to be determined.

Below, various embodiments of a method by which a sink device efficiently obtains thumbnails of duplicate files from source devices storing duplicate files are described.

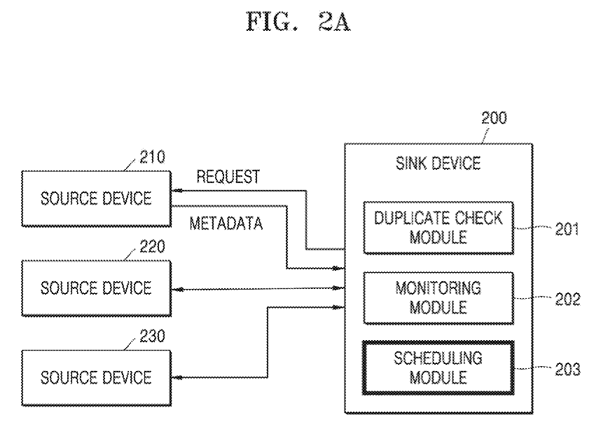

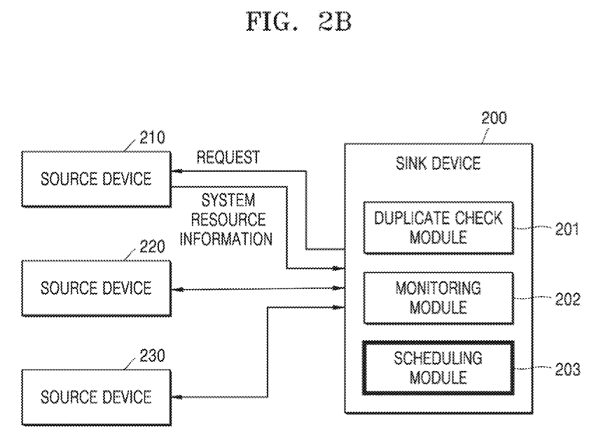

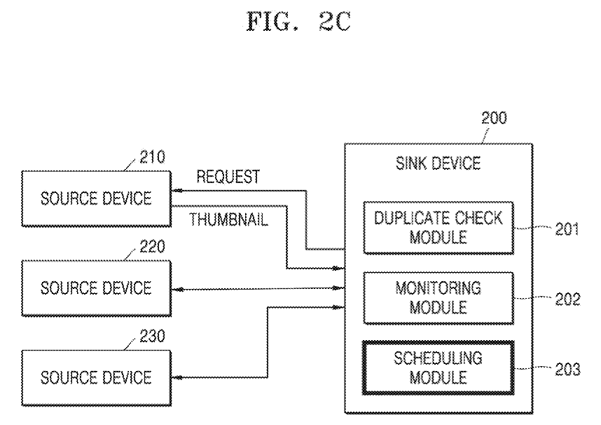

FIG. 2A is a diagram illustrating a duplicate check module 201 of a sink device 200, according to an embodiment.

The sink device 200 may include the duplicate check module 201, a monitoring module 202, and a scheduling module 203. The monitoring module 202 and the scheduling module 203 are described later with reference to FIGS. 2B and 2C.

The modules 201, 202, 203 illustrated in FIGS. 2A-2C may be actually components implemented by at least one processor included in the sink device 200 that executes a program or command stored in memory included in the sink device 200. Accordingly, operations described below as being performed by the modules 201, 202, 203 of the sink device 200 may be actually performed by at least one processor included in the sink device 200.

In an embodiment, the duplicate check module 201 may determine whether multimedia files stored in source devices 210, 220, 230 are duplicate files. For example, the duplicate check module 201 may determine whether multimedia files are duplicate files by comparing hash values of the multimedia files. For example, the duplicate check module 201 may determine whether multimedia files are duplicate files by comparing hash values of metadata of multimedia files. For example, the duplicate check module 201 may determine multimedia files having hash values matching each other as duplicate files.

The metadata of the multimedia file may include at least one of hash values of the multimedia files or hash values of metadata of the multimedia files. Accordingly, the duplicate check module 201 may determine whether multimedia files are duplicate files by requesting metadata of the multimedia files from the source devices 210, 220, 230, receiving the metadata of the multimedia files from the source devices 210, 220, 230 in response, and comparing hash values included in the received metadata.

In an embodiment, the duplicate check module 201 may automatically request metadata of multimedia files from the source devices 210, 220, 230 when the source devices 210, 220, 230 are connected to the sink device 200. In an embodiment, the duplicate check module 201 may request metadata of multimedia files from the source devices 210, 220, 230 in response to user input.

The metadata of the multimedia file received from the source device by the duplicate check module 201 may include information about whether the source device stores a thumbnail of the multimedia file.

In an embodiment, the duplicate check module 201 may generate a duplicate file list based on the metadata of the multimedia files received from the source devices 210, 220, 230. The duplicate check module 201 may determine which multimedia files from among the multimedia files stored in the source devices 210, 220, 230 are duplicate files, which source device stores the duplicate files, and which source device stores the thumbnails of the duplicate files, based on information included in the metadata of the multimedia files. Accordingly, the duplicate file list may list duplicate files, source devices storing the duplicate files, and source devices storing thumbnails of the duplicate files.

In some embodiments, metadata of a multimedia file may not include information about whether a source device stores a thumbnail of the multimedia file. In this case, the duplicate check module 201 may separately request information about whether each of the source devices 210, 220, 230 stores a thumbnail of the multimedia file, from the metadata of the multimedia file.

FIG. 2B is a diagram illustrating the monitoring module 202 of the sink device 200, according to an embodiment.

The monitoring module 202 may receive system resource information of the source devices 210, 220, 230 from the source devices 210, 220, 230. System resource information may include at least one of hardware resource information including hardware specifications of hardware such as processors, memory, and hardware accelerators and on whether the hardware is mounted; system performance information including processor usage, memory usage, and hardware accelerator usage; or network information including transmission speed, bandwidth, and usage of a network connected between a source device and a sink device.

In an embodiment, the monitoring module 202 may receive information from the source devices 210, 220, 230 regarding whether the source devices 210, 220, 230 have the capability to generate thumbnails.

The monitoring module 202 may request system resource information from each of the source devices 210, 220, 230 and receive the system resource information from each of the source devices 210, 220, 230 in response.

The monitoring module 202 may automatically request system resource information from the source devices 210, 220, 230 when the source devices 210, 220, 230 are connected to the sink device 200. Alternatively, the monitoring module 202 may request system resource information from the source devices 210, 220, 230 in response to user input. Alternatively, the monitoring module 202 may request system resource information from the source devices 210, 220, 230 when the sink device 200 requests duplicate files or thumbnails of the duplicate files from the source devices 210, 220, 230.

The monitoring module 202 may request fixed system resource information, such as hardware specifications, from the source devices 210, 220, 230 once, and may request changing system resource information, such as processor usage and memory usage, from the source devices 210, 220, 230 multiple times periodically or aperiodically.

The monitoring module 202 may request system resource information from each of all source devices 210, 220, 230 connected to the sink device 200. Alternatively, the monitoring module 202 may select source devices storing duplicate files from among all of the source devices 210, 220, 230 connected to the sink device 200 based on the duplicate file list, and request system resource information from each of the selected source devices.

FIG. 2C is a diagram illustrating the scheduling module 203 of the sink device 200, according to an embodiment.

The scheduling module 203 may schedule how many thumbnails of duplicate files the sink device 200 is to obtain from which source devices. The scheduling module 203 may determine the number of duplicate files to be allocated to each source device among the number of duplicate files stored in the source device for each of the source devices 210, 220, 230.

In an embodiment, the scheduling module 203 may determine an allocated number for each of the source devices 210, 220, 230 so as to minimize a time required to receive thumbnails of duplicate files from the source devices 210, 220, 230.

For example, when the source devices 210, 220, 230 each have four duplicate files, and when the time required to receive thumbnails of the duplicate files from the source devices 210, 220, 230 is minimized by receiving a thumbnail of one duplicate file from the first source device 210, receiving thumbnails of two duplicate files from the second source device 220, and receiving a thumbnail of the remaining one duplicate file from the third source device 230, the scheduling module 203 may determine the allocated number for the first source device 210 as 1, the allocated number for the second source device 220 as 2, and the allocated number for the third source device 230 as 1.

The matter of determining of the allocated number for each of the source devices 210, 220, 230 so as to minimize the time required to receive thumbnails of duplicate files from the source devices 210, 220, 230 is a matter of optimization. In an embodiment, the scheduling module 203 may utilize various optimization techniques to determine the allocated number for each of the source devices 210, 220, 230.

In an embodiment, the time required to receive thumbnails of duplicate files from the source devices 210, 220, 230 may include a transmission time for transmitting thumbnails of the allocated number of duplicate files from each of the source devices 210, 220, 230 to the sink device 200.

For each of the source devices 210, 220, 230, the scheduling module 203 may estimate the transmission time for transmitting thumbnails of the allocated number of duplicate files from the source device to the sink device 200 based on system resource information of a source device.

For example, the scheduling module 203 may estimate that the transmission time for transmitting thumbnails of duplicate files is shorter as a transmission speed of a network of a source device is higher.

For example, the scheduling module 203 may estimate that the transmission time for transmitting thumbnails of duplicate files is longer as a network usage of the source device is high.

The scheduling module 203 may determine the allocated number for each of the source devices 210, 220, 230 such that a source device with a shorter estimated transmission time has a larger allocated number. Accordingly, the time required to receive thumbnails of duplicate files from the source devices 210, 220, 230 may be minimized.

For example, when the estimated transmission time of the first source device 210 is 100 ms, the estimated transmission time of the second source device 220 is 200 ms, the estimated transmission time of the third source device 230 is 400 ms, and the number of duplicate files stored in each of the source devices 210, 220, 230 is 70, the scheduling module 203 may determine the allocated number for the first source device 210 to be 40, the allocated number for the second source device 220 to be 20, and the allocated number for the third source device 230 to be 10.

In an embodiment, the time required to receive thumbnails of duplicate files from the source devices 210, 220, 230 may include a generation time for the source devices 210, 220, 230 to generate thumbnails of an allocated number of duplicate files and a transmission time for transmitting the generated thumbnails from the source devices 210, 220, 230 to the sink device 200.

The scheduling module 203 may estimate, for each of the source devices 210, 220, 230, a generation time during which a source device generates thumbnails of the allocated number of duplicate files and a transmission time during which the generated thumbnails are transmitted from the source device to the sink device 200, based on the system resource information of the source device.

For example, the scheduling module 203 may estimate that the generation time for generating a thumbnail is shorter as the hardware specifications of the source device are higher.

For example, the scheduling module 203 may estimate a shorter generation time for generating a thumbnail when the source device includes a hardware accelerator than when the source device does not include a hardware accelerator.

For example, the scheduling module 203 may estimate that the generation time for generating a thumbnail is longer as the hardware usage of the source device is higher.

The scheduling module 203 may determine the allocated number for each of the source devices 210, 220, 230 such that a source device with a shorter sum of the estimated generation time and the estimated transmission time has a larger allocated number. Accordingly, the time required to receive thumbnails of duplicate files from the source devices 210, 220, 230 may be minimized.

For example, when the sum of the estimated generation time and the estimated transmission time of the first source device 210 is 250ms, the sum of the estimated generation time and the transmission time of the second source device 220 is 750 ms, the sum of the estimated generation time and the transmission time of the third source device 230 is 500 ms, and the number of duplicate files stored in each of the source devices 210, 220, 230 is 40, the scheduling module 203 may determine the allocated number for the first source device 210 to be 25, the allocated number for the second source device 220 to be 5, and the allocated number for the third source device 230 to be the remaining 10.

The scheduling module 203 may request thumbnails of an allocated number of duplicate files from each of the source devices 210, 220, 230. In response, each of the source devices 210, 220, 230 may transmit thumbnails of the allocated number of duplicate files to the scheduling module 203.

For example, when the number of duplicate files stored in each of the source devices 210, 220, 230 is 10, the allocated number for the first source device 210 is 5, the allocated number for the second source device 220 is 2, and the allocated number for the third source device 230 is 3, the scheduling module 203 may request thumbnails of the 5 duplicate files from the first source device 210, request thumbnails of the 2 duplicate files from the second source device 220, and request thumbnails of the remaining 3 duplicate files from the third source device 230.

The scheduling module 203 may preferentially request thumbnails from a source device that stores thumbnails of duplicate files. For example, when there are no thumbnails of duplicate files in the first source device 210 and there are thumbnails of duplicate files in the second and third source devices 220, 230, the scheduling module 203 may receive thumbnails of duplicate files from the second and third source devices 220, 230. In this case, the scheduling module 203 may determine the allocated number for each of the second and third source devices 220, 230 so as to minimize the time required to receive thumbnails of duplicate files from the second and third source devices 220, 230.

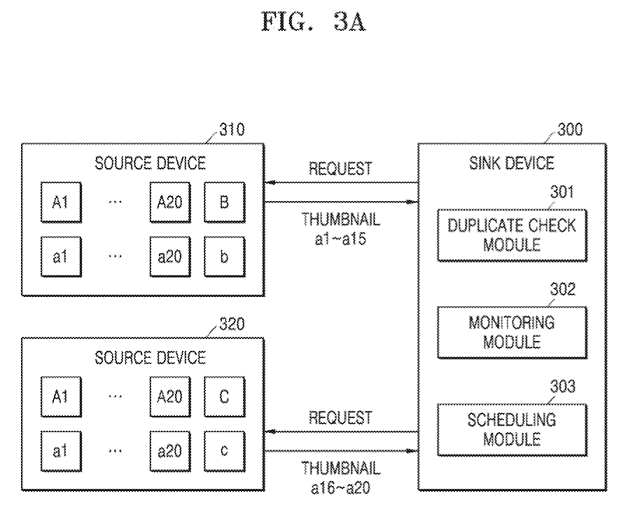

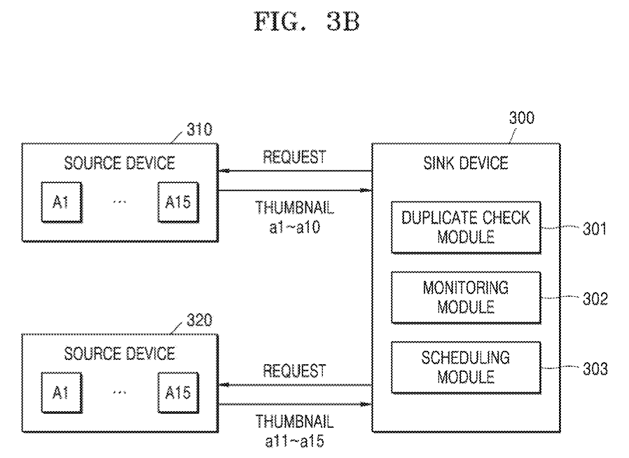

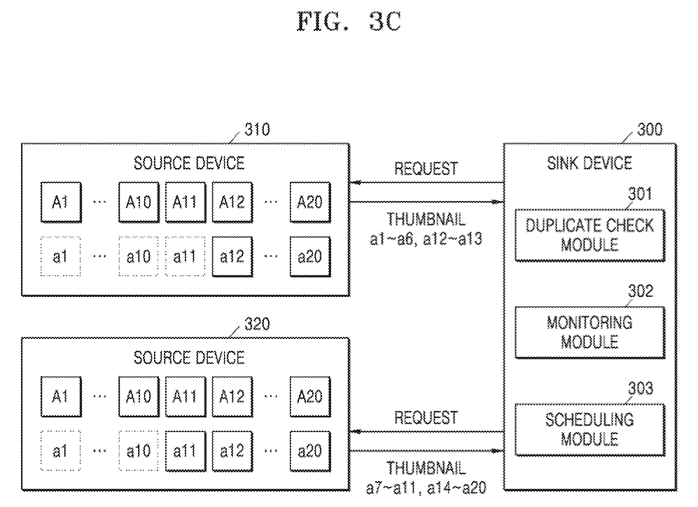

FIG. 3A is a diagram illustrating a scenario in which a sink device 300 obtains thumbnails, according to an embodiment.

In a scenario according to an embodiment, a first source device 310 and a second source device 320 are connected to the sink device 300.

In a scenario according to an embodiment, the first source device 310 stores multimedia files (A1 to A20, B) and thumbnails (a1 to a20, b), and the second source device 320 stores multimedia files (A1 to A20, C) and thumbnails (a1 to a20, c).

In a scenario according to an embodiment, the thumbnails a1 to a20 are thumbnails of multimedia files A1 to A20, respectively.

A duplicate check module 301 requests metadata of multimedia files from the first and second source devices 310, 320. In response to the request, the duplicate check module 301 receives metadata of multimedia files (A1 to A20, B) from the first source device 310 and receives metadata of multimedia files (A1 to A20, C) from the second source device 320.

In a scenario according to an embodiment, metadata received from the first source device 310 includes hash values of multimedia files (A1 to A20, B) of the first source device 310 and information indicating that the first source device 310 stores thumbnails (a1 to a20, b). The metadata received from the second source device 320 includes hash values of multimedia files (A1 to A20, C) of the second source device 320 and information indicating that the second source device 320 stores thumbnails (a1 to a20, c).

The duplicate check module 301 detects duplicate files A1 to A20 among all multimedia files (A1 to A20, B, C) based on metadata received from the first and second source devices 310, 320. In more detail, the duplicate check module 301 detects the multimedia files A1 to A20 corresponding to the same hash values as the duplicate files A1 to A20.

The duplicate check module 301 generates duplicate file list. In a scenario according to an embodiment, the duplicate file list lists the duplicate files A1 to A20, the source devices 310, 320 including the duplicate files A1 to A20, and the source devices 310, 320 including thumbnails a1 to a20 of the duplicate files.

In a scenario according to an embodiment, a monitoring module 302 requests system resource information from each of the source devices 310, 320 on the duplicate file list. In response to the request, the monitoring module 302 receives the system resource information of the first source device 310 from the first source device 310 and receives the system resource information of the second source device 320 from the second source device 320.

In a scenario according to an embodiment, the system resource information of the first source device 310 includes a transmission speed of 100 Mbps of the network between the first source device 310 and the sink device 300. Additionally, the system resource information of the second source device 320 includes a transmission speed of 20 Mbps of the network between the second source device 320 and the sink device 300.

For the duplicate files A1 to A20, a scheduling module 303 determines that both the first and second source devices 310, 320 store the thumbnails a1 to a20 of the duplicate files based on the duplicate file list.

For the thumbnails a1 to a20, the scheduling module 303 estimates the transmission time for transmitting the allocated number of thumbnails from the first source device 310 to the sink device 300 based on the system resource information of the first source device 310. Additionally, for the thumbnails a1 to a20, the scheduling module 303 estimates the transmission time for transmitting the allocated number of thumbnails from the second source device 320 to the sink device 300 based on the system resource information of the second source device 320. A predetermined initial allocated number may be used for the initial estimate.

The scheduling module 303 determines the allocated number for each of the source devices 310, 320 based on the estimated transmission time so as to minimize the time required to receive the thumbnails a1 to a20 from the source devices 310, 320.

In a scenario according to an embodiment, the estimated transmission time for the first source device 310 is shorter than the estimated transmission time for the second source device 320. Accordingly, the scheduling module 303 determines a larger allocated number for the first source device 310 than for the second source device 320.

In a scenario according to an embodiment, the scheduling module 303 determines an allocated number of 15 for the first source device 310 and an allocated number of 5 for the second source device 320.

The scheduling module 303 requests thumbnails of the allocated number of duplicate files from each of the source devices 310, 320.

In a scenario according to an embodiment, the scheduling module 303 requests 15 thumbnails a1 to a15 from the first source device 310 and receives the 15 thumbnails a1 to a15 from the first source device 310 in response thereto. Additionally, the scheduling module 303 requests five thumbnails (a16 to a20) from the second source device 320, and in response receives the five thumbnails (a16 to a20) from the second source device 320.

FIG. 3B is a diagram illustrating a scenario in which the sink device 300 obtains thumbnails, according to an embodiment.

In a scenario according to an embodiment, the first source device 310 and the second source device 320 are connected to the sink device 300.

In a scenario according to an embodiment, the first source device 310 stores the multimedia files A1 to A15, and the second source device 320 stores multimedia files A1 to A15.

In a scenario according to an embodiment, the thumbnails a1 to a15 are thumbnails of the multimedia files A1 to A15, respectively.

The duplicate check module 301 requests metadata of multimedia files from the first and second source devices 310, 320. In response to the request, the duplicate check module 301 receives metadata of the multimedia files A1 to A15 from the first source device 310 and receives metadata of the multimedia files A1 to A15 from the second source device 320.

In a scenario according to an embodiment, metadata received from the first source device 310 includes hash values of the multimedia files A1 to A15 of the first source device 310 and information indicating that the first source device 310 does not store thumbnails a1 to a15 of the multimedia files A1 to A15. The metadata received from the second source device 320 includes hash values of the multimedia files A1 to A15 of the second source device 320 and information indicating that the second source device 320 does not store the thumbnails a1 to a15 of the multimedia files A1 to A15.

The duplicate check module 301 detects all multimedia files A1 to A15 as duplicate files A1 to A15 based on the metadata received from the first and second source devices 310, 320.

The duplicate check module 301 generates a duplicate file list. In a scenario according to an embodiment, the duplicate file list lists the duplicate files A1 to A15, the source devices 310, 320 including the duplicate files A1 to A15, and information indicating that the first and second source devices 310, 320 do not store the thumbnails a1 to a15.

In a scenario according to an embodiment, the monitoring module 302 requests system resource information from each of the source devices 310, 320 on the duplicate file list. In response to the request, the monitoring module 302 receives the system resource information of the first source device 310 from the first source device 310 and receives the system resource information of the second source device 320 from the second source device 320.

In a scenario according to an embodiment, the system resource information of the first source device 310 includes hardware resource information including a 2.4 GHz and 8-core Central Processing Unit (CPU), 100 GB of memory, and a hardware accelerator, system performance information including 5% CPU usage, 11% memory usage, and 1% hardware accelerator usage, and network information including a transmission speed of 200 Mbps and 45% network usage. The system resource information of the second source device 320 includes hardware resource information including a 1 Ghz and 1 core CPU and 500 MB of memory, system performance information including 40% CPU usage and 60% memory usage, and network information including a transmission speed of 500 Mbps and 25% network usage.

The scheduling module 303 determines, based on the duplicate file list, that neither of the first nor second source devices 310, 320 stores the thumbnails a1 to a15 of the duplicate files.

The scheduling module 303 estimates, based on the system resource information of the first source device 310, a generation time during which the first source device 310 generates the allocated number of thumbnails and a transmission time during which the generated thumbnails are transmitted from the first source device 310 to the sink device 300. Additionally, the scheduling module 303 estimates, based on the system resource information of the second source device 320, a generation time during which the second source device 320 generates the allocated number of thumbnails and a transmission time during which the generated thumbnails are transmitted from the second source device 320 to the sink device 300. A predetermined initial allocated number may be used for the initial estimate.

The scheduling module 303 determines the allocated number for each of the source devices 310, 320 so as to minimize the time required to receive the thumbnails a1 to a15 from the source devices 310, 320 based on a sum of the estimated generation time and the estimated transmission time.

In a scenario according to an embodiment, the sum of the estimated generation time and estimated transmission time for the first source device 310 is shorter than the sum of the estimated generation time and the estimated transmission time for the second source device 320. Accordingly, the scheduling module 303 determines a larger allocated number for the first source device 310 than for the second source device 320.

In a scenario according to an embodiment, the scheduling module 303 determines an allocated number of 10 for the first source device 310 and an allocated number of 5 for the second source device 320.

The scheduling module 303 requests thumbnails of the allocated number of duplicate files from each of the source devices 310, 320.

In a scenario according to an embodiment, the scheduling module 303 requests 10 thumbnails a1 to a10 from the first source device 310. In response thereto, the first source device 310 generates 10 thumbnails a1 to a10 from 10 duplicate files A1 to A10 and transmits the generated thumbnails a1 to a10 to the scheduling module 303. Additionally, the scheduling module 303 requests five thumbnails a11 to a15 from the second source device 320. In response thereto, the second source device 320 generates five thumbnails a11 to a15 from five duplicate files A11 to A15 and transmits the generated thumbnails a11 to a15 to the scheduling module 303.

FIG. 3C is a diagram illustrating a scenario in which a sink device obtains thumbnails, according to an embodiment.

In a scenario according to an embodiment, the first source device 310 and the second source device 320 are connected to the sink device 300.

In a scenario according to an embodiment, the first source device 310 stores the multimedia files A1 to A20 and thumbnails a12 to a20, and the second source device 320 stores the multimedia files A1 to A20 and thumbnails a11 to a20.

In a scenario according to an embodiment, the thumbnails a1 to a20 are thumbnails of the multimedia files A1 to A20, respectively.

The duplicate check module 301 requests metadata of multimedia files from the first and second source devices 310, 320. In response to the request, the duplicate check module 301 receives metadata of the multimedia files A1 to A20 from the first source device 310 and receives metadata of the multimedia files A1 to A20 from the second source device 320.

In a scenario according to an embodiment, metadata received from the first source device 310 includes hash values of the multimedia files A1 to A20 of the first source device 310, information indicating that the first source device 310 does not store thumbnails a1 to a11, and information indicating that the first source device 310 stores the thumbnails a12 to a20. The metadata received from the second source device 320 includes hash values of the multimedia files A1 to A20 of the second source device 320, information indicating that the second source device 320 does not store the thumbnails a1 to a10, and information indicating that the second source device 320 stores thumbnails a11 to a20.

The duplicate check module 301 detects all multimedia files A1 to A20 as the duplicate files A1 to A20 based on the metadata received from the first and second source devices 310, 320.

The duplicate check module 301 generates a duplicate file list. In a scenario according to an embodiment, the duplicate file list lists the duplicate files A1 to A20, the source devices 310, 320 including the duplicate files A1 to A20, information indicating that the first source device 310 does not store the thumbnails a1 to a11, information indicating that the first source device 310 stores the thumbnails a12 to a20, information indicating that the second source device 320 does not store the thumbnails a1 to a10, and information indicating that the second source device 320 stores the thumbnails a11 to a20.

In a scenario according to an embodiment, the monitoring module 302 requests system resource information from each of the source devices 310, 320 on the duplicate file list. In response to the request, the monitoring module 302 receives the system resource information of the first source device 310 from the first source device 310 and receives the system resource information of the second source device 320 from the second source device 320.

In a scenario according to an embodiment, the system resource information of the first source device 310 and the system resource information of the second source device 320 are the same as in the scenario according to an embodiment with reference to FIG. 3b.

In a scenario according to an embodiment, for the duplicate files A1 to A20, the scheduling module 303 determines that the first and second source devices 310, 320 do not store the thumbnails a1 to a10 based on the duplicate file list.

For the thumbnails a1 to a10, the scheduling module 303 estimates a generation time during which the first source device 310 generates an allocated number of thumbnails and a transmission time during which the generated thumbnails are transmitted from the first source device 310 to the sink device 300 based on the system resource information of the first source device 310. In addition, for the thumbnails a1 to a10, the scheduling module 303 estimates a generation time during which the second source device 320 generates an allocated number of thumbnails and a transmission time during which the generated thumbnails are transmitted from the second source device 320 to the sink device 300 based on the system resource information of the second source device 320. A predetermined initial allocated number may be used for the initial estimate.

The scheduling module 303 determines the allocated number for each of the source devices 310, 320 so as to minimize the time required to receive the thumbnails a1 to a10 from the source devices 310, 320 based on the sum of the estimated generation time and the estimated transmission time.

In a scenario according to an embodiment, the sum of the estimated generation time and the estimated transmission time for the first source device 310 is shorter than the sum of the estimated generation time and the estimated transmission time for the second source device 320. Accordingly, the scheduling module 303 determines a larger allocated number for the first source device 310 than for the second source device 320.

In a scenario according to an embodiment, the scheduling module 303 determines an allocated number of six for the first source device 310 and an allocated number of four for the second source device 320.

The scheduling module 303 requests thumbnails of the allocated number of duplicate files from each of the source devices 310, 320.

In a scenario according to an embodiment, the scheduling module 303 requests six thumbnails a1 to a6 from the first source device 310. In response thereto, the first source device 310 generates six thumbnails a1 to a6 from six duplicate files A1 to A6 and transmits the generated thumbnails a1 to a6 to the scheduling module 303. Additionally, the scheduling module 303 requests four thumbnails a7 to a10 from the second source device 320. In response thereto, the second source device 320 generates four thumbnails a7 to a10 from four duplicate files A7 to A10 and transmits the generated thumbnails a7 to a10 to the scheduling module 303.

In a scenario according to an embodiment, for a duplicate file A11, the scheduling module 303 determines that only the second source device 320 stores the thumbnail a11 based on the duplicate file list.

The scheduling module 303 requests a thumbnail a11 from the second source device 320 and receives the thumbnail a11 from the second source device 320 in response.

In a scenario according to an embodiment, for duplicate files A12 to A20, the scheduling module 303 determines that the first and second source devices 310, 320 store the thumbnails a12 to a20 based on the duplicate file list.

The scheduling module 303 estimates a transmission time for transmitting thumbnails of an allocated number of duplicate files from the first source device 310 to the sink device 300 based on the system resource information of the first source device 310. Additionally, the scheduling module 303 estimates a transmission time for transmitting thumbnails of the allocated number of duplicate files from the second source device 320 to the sink device 300 based on the system resource information of the second source device 320. A predetermined initial allocated number may be used for the initial estimate.

The scheduling module 303 determines the allocated number for each of the source devices 310, 320 based on the estimated transmission time so as to minimize the time required to receive the thumbnails a12 to a20 from the source devices 310, 320.

In a scenario according to an embodiment, the estimated transmission time for the first source device 310 is longer than the estimated transmission time for the second source device 320. Accordingly, the scheduling module 303 determines a larger allocated number for the second source device 320 than for the first source device 310.

In a scenario according to an embodiment, the scheduling module 303 determines an allocated number of two for the first source device 310 and an allocated number of seven for the second source device 320.

The scheduling module 303 requests thumbnails of the allocated number of duplicate files from each of the source devices 310, 320.

In a scenario according to an embodiment, the scheduling module 303 requests two thumbnails a12 to a13 from the first source device 310 and receives two thumbnails a12 to a13 from the first source device 310 in response thereto. Additionally, the scheduling module 303 requests seven thumbnails a14 to a20 from the second source device 320, and in response, receives seven thumbnails a14 to a20 from the second source device 320.

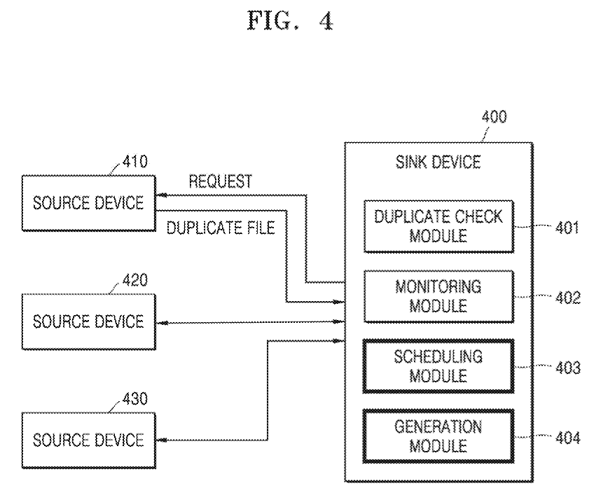

FIG. 4 is a diagram illustrating a scheduling module 403 and a generation module 404 of a sink device 400 according to an embodiment.

The sink device 400 may include a duplicate check module 401, a monitoring module 402, the scheduling module 403, and the generation module 404.

The modules 401, 402, 403, 404 illustrated in FIG. 4 may be actually components implemented by at least one processor included in the sink device 400 executing a program or command stored in memory included in the sink device 400. Accordingly, the operations described below as being performed by the modules 401, 402, 403, 404 of the sink device 400 may be actually performed by at least one processor included in the sink device 400.

The description with reference to FIGS. 2A-3C may be applied to the sink device 400 of FIG. 4. For the convenience of description, repeated explanations are omitted.

When a time required for the sink device 400 to receive duplicate files from source devices 410, 420, 430 and generate thumbnails of the duplicate files from the received duplicate files is shorter than a time required for the source devices 410, 420, 430 to generate thumbnails of the duplicate files and transmit the generated thumbnails of the duplicate files to the sink device 400, the sink device 400 may receive duplicate files from the source devices 410, 420, 430 and generate thumbnails from the received duplicate files.

The scheduling module 403 may estimate the time required for the sink device 400 to receive duplicate files from the source devices 410, 420, 430 and to generate thumbnails of the duplicate files from the received duplicate files, based on system resource information of the sink device 400 and system resource information of the source devices 410, 420, 430. Additionally, the scheduling module 403 may estimate the time required for the source devices 410, 420, 430 to generate thumbnails of duplicate files and transmit the generated thumbnails of duplicate files to the sink device 400, based on the system resource information of the source devices 410, 420, 430.

Based on the estimated time required, the scheduling module 403 may determine which method may obtain the thumbnails faster. When the sink device 400 determines that receiving duplicate files from the source devices 410, 420, 430 and generating thumbnails of the duplicate files from the received duplicate files is a faster method, the scheduling module 403 may decide to receive the duplicate files from the source devices 410, 420, 430. In other cases, the scheduling module 403 may decide to receive thumbnails from the source devices 410, 420, 430.

The scheduling module 403 may schedule how many duplicate files the sink device 400 is to obtain from which source devices. The scheduling module 403 may determine the number of duplicate files to be allocated to each source device among the number of duplicate files stored in the source device for each of the source devices 410, 420, 430.

In an embodiment, the scheduling module 403 may determine the allocated number for each of the source devices 410, 420, 430 so as to minimize the time required to receive duplicate files from the source devices 410, 420, 430.

For example, when the time required to receive the duplicate files from the source devices 410, 420, 430 is minimized when the source devices 410, 420, 430 each have five duplicate files, receive two duplicate files from the first source device 410, receive two duplicate files from the second source device 420, and receive the remaining one duplicate file from the third source device 430, the scheduling module 403 may determine the allocated number for the first source device 410 to be 2, the allocated number for the second source device 420 to be 2, and the allocated number for the third source device 430 to be 1.

The matter of determining the allocated number for each of the source devices 410, 420, 430 so as to minimize the time required to receive duplicate files from the source devices 410, 420, 430 is a matter of optimization. In an embodiment, the scheduling module 403 may utilize various optimization techniques to determine the allocated number for each of the source devices 410, 420, 430.

In an embodiment, the time required to receive duplicate files from the source devices 410, 420, 430 may include a transmission time for transmitting an allocated number of duplicate files from each of the source devices 410, 420, 430 to the sink device 400.

For each of the source devices 410, 420, 430, the scheduling module 403 may estimate the transmission time for transmitting the allocated number of duplicate files from a source device to the sink device 400 based on the system resource information of the source device.

For example, the scheduling module 403 may estimate a shorter transmission time for transmitting duplicate files as a transmission speed of a network of the source device increases.

For example, the scheduling module 403 may estimate that the transmission time for transmitting duplicate files is longer as a network usage of the source device is high.

The scheduling module 403 may determine the allocated number for each of the source devices 410, 420, 430 such that a source device with a shorter estimated transmission time has a larger allocated number. Accordingly, the time required to receive duplicate files from the source devices 410, 420, 430 may be minimized.

The scheduling module 403 may request an allocated number of duplicate files from each of the source devices 410, 420, 430. In response, each of the source devices 410, 420, 430 may transmit an allocated number of duplicate files to the scheduling module 403.

The generation module 404 may generate thumbnails from duplicate files received from the source devices 410, 420, 430. For example, the generation module 404 may generate thumbnails by using the same thumbnail generation technique as the source devices 410, 420, 430.

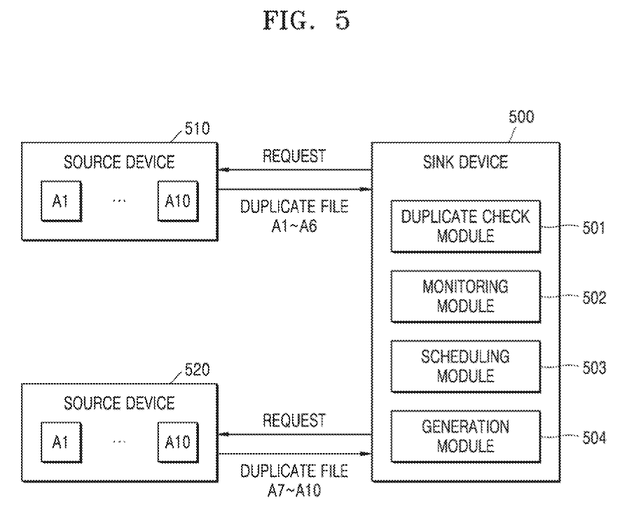

FIG. 5 is a diagram illustrating a scenario in which a sink device 500 obtains thumbnails, according to an embodiment.

In a scenario according to an embodiment, a first source device 510 and a second source device 520 are connected to the sink device 500.

In a scenario according to an embodiment, the first source device 510 stores multimedia files A1 to A10, and the second source device 520 stores the multimedia files A1 to A10.

A duplicate check module 501 requests metadata of multimedia files from the first and second source devices 510, 520. In response to the request, the duplicate check module 501 receives metadata of the multimedia files A1 to A10 from the first source device 510 and receives the metadata of the multimedia files A1 to A10 from the second source device 520.

In a scenario according to an embodiment, metadata received from the first source device 510 includes hash values of the multimedia files A1 to A10 of the first source device 510 and information indicating that the first source device 510 does not store thumbnails of the multimedia files A1 to A10. The metadata received from the second source device 520 includes hash values of the multimedia files A1 to A10 of the second source device 520 and information indicating that the second source device 520 does not store thumbnails of the multimedia files A1 to A10.

The duplicate check module 501 detects all multimedia files A1 to A10 as duplicate files A1 to A10 based on the metadata received from the first and second source devices 510, 520.

The duplicate check module 501 generates a duplicate file list. In a scenario according to an embodiment, the duplicate file list lists the duplicate files A1 to A10, source devices 510, 520 including the duplicate files A1 to A10, and information indicating that the first and second source devices 510, 520 do not store thumbnails of the duplicate files A1 to A10.

In a scenario according to an embodiment, a monitoring module 502 requests system resource information from each of the source devices 510, 520 on the duplicate file list. In response to the request, the monitoring module 502 receives system resource information of the first source device 510 from the first source device 510 and receives system resource information of the second source device 520 from the second source device 520.

A scheduling module 503 determines that the first and second source devices 510, 520 do not store thumbnails of the duplicate files A1 to A10 based on the duplicate file list.

The scheduling module 503 determines that the time required for the sink device 500 to receive the duplicate files A1 to A10 from the source devices 510, 520 and to generate thumbnails of the duplicate files A1 to A10 from the received duplicate files A1 to A10 is shorter than the time required for the source devices 510, 520 to generate thumbnails of the duplicate files A1 to A10 and to transmit the generated thumbnails of the duplicate files A1 to A10 to the sink device 500, and determines to receive the duplicate files A1 to A10 from the source devices 510, 520.

The scheduling module 503 estimates a transmission time for transmitting an allocated number of duplicate files from the first source device 510 to the sink device 500 based on the system resource information of the first source device 510. Additionally, the scheduling module 503 estimates a transmission time for transmitting an allocated number of duplicate files from the second source device 520 to the sink device 500 based on the system resource information of the second source device 520. A predetermined initial allocated number may be used for the initial estimate.

The scheduling module 503 determines the allocated number for each of the source devices 510, 520 based on the estimated transmission time so as to minimize the time required to receive the duplicate files A1 to A10 from the source devices 510, 520.

In a scenario according to an embodiment, the scheduling module 503 determines an allocated number of six for the first source device 510 and an allocated number of four for the second source device 520.

The scheduling module 503 requests an allocated number of duplicate files from each of the source devices 510, 520.

In a scenario according to an embodiment, the scheduling module 503 requests six duplicate files A1 to A6 from the first source device 510 and, in response, receives six duplicate files A1 to A6 from the first source device 510. Additionally, the scheduling module 503 requests four duplicate files A7 to A10 from the second source device 520, and in response, receives the four duplicate files A7 to A10 from the second source device 520.

In a scenario according to an embodiment, a generation module 504 generates thumbnails of duplicate files A1 to A6 from the duplicate files A1 to A6 received from the first source device 510. Additionally, the generation module 504 generates thumbnails of duplicate files A7 to A10 from the duplicate files A7 to A10 received from the second source device 520.

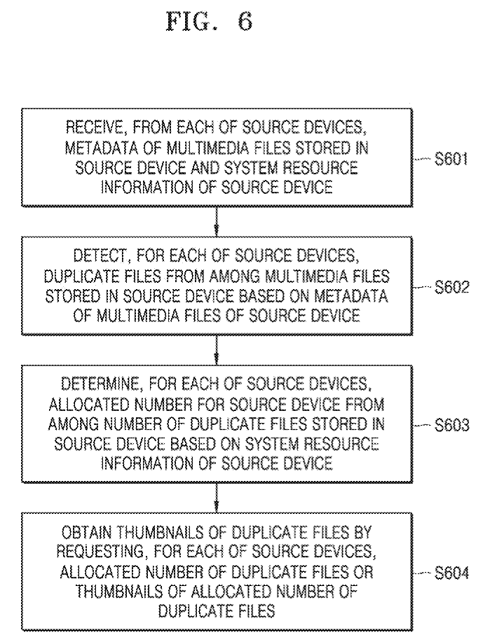

FIG. 6 is a flowchart of a method by which a sink device obtains thumbnails for duplicate files present in source devices, according to an embodiment.

In operation S601, the sink device receives, from each of the source devices, metadata of multimedia files stored in the source device and system resource information of the source device.

In an embodiment, the sink device may receive metadata of multimedia files stored on each of the source devices from each of the source devices. Additionally, the sink device may receive system resource information of each source device from each source device.

In operation S602, the sink device detects, for each of source devices, duplicate files from among multimedia files stored in the source device based on metadata of the multimedia files of the source device.

In an embodiment, the sink device may detect duplicate files from among multimedia files based on the metadata of the multimedia files. The sink device may detect duplicate files from among multimedia files by comparing hash values included in the metadata of the multimedia files. More specifically, the sink device may detect multimedia files with identical hash values as duplicate files.

In an embodiment, the source devices may generate hash values by using the same hash function. Accordingly, the sink device may detect duplicate files from among multimedia files by comparing hash values. The hash values used to detect duplicate files may include hash values of multimedia files and hash values of metadata of the multimedia files.

In operation S603, the sink device determines, for each of the source devices, the number of duplicate files to be allocated to the source device from among the number of duplicate files stored in the source device based on the system resource information of the source device.

In an embodiment, the sink device may determine whether to receive thumbnails of duplicate files from the source devices or to receive duplicate files from the source devices.

In an embodiment, the sink device may determine to receive duplicate files from the source devices when the source devices do not store thumbnails of duplicate files and the time required for the sink device to receive duplicate files from the source devices and generate thumbnails of the duplicate files is determined to be shorter than the time required for the source devices to generate thumbnails of the duplicate files and transmit the same to the sink device. In other cases, the sink device may determine to receive thumbnails of duplicate files from the source devices.

In an embodiment, the sink device may determine whether the source device stores thumbnails of duplicate files based on metadata of multimedia files received from the source device.

In an embodiment, the sink device may estimate, based on system resource information of the source devices and system resource information of the sink device, a time required for the sink device to receive duplicate files from the source devices and generate thumbnails of the duplicate files and a time required for the source devices to generate thumbnails of the duplicate files and transmit the same to the sink device.

In an embodiment, when a sink device determines to receive thumbnails of duplicate files from source devices, the sink device may determine an allocated number for each of the source devices such that the time required to receive thumbnails of duplicate files from the source devices is minimized.

In an embodiment, when a sink device determines to receive duplicate files from source devices, the sink device may determine an allocated number for each of the source devices such that the time required to receive duplicate files from the source devices is minimized.

In operation S604, the sink device obtains thumbnails of duplicate files by requesting, for each of source devices, an allocated number of duplicate files or thumbnails of an allocated number of duplicate files.

In an embodiment, when the sink device determines to receive thumbnails of duplicate files from the source devices, the sink device may request an allocated number of thumbnails of duplicate files for each of the source devices. The sink device may obtain thumbnails for duplicate files stored on the source devices by receiving thumbnails of an allocated number of duplicate files from each of the source devices in response to a request.

In an embodiment, when the sink device determines to receive duplicate files from the source devices, the sink device may request an allocated number of duplicate files for each of the source devices. The sink device may receive an allocated number of duplicate files from each of the source devices in response to a request. The sink device may obtain thumbnails for duplicate files stored on the source devices by generating thumbnails from the received duplicate files.

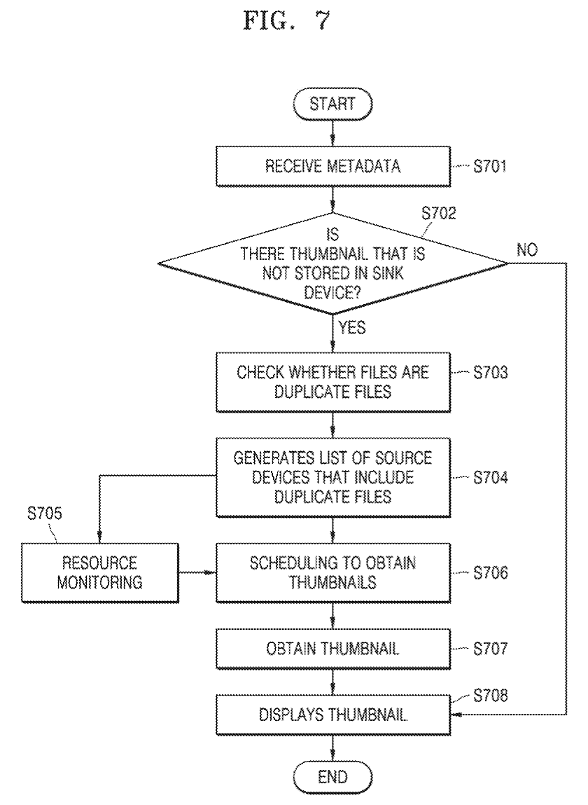

FIG. 7 is a flowchart of a method by which a sink device obtains thumbnails for duplicate files present in source devices, according to an embodiment.

In operation S701, the sink device receives metadata of multimedia files from the source devices connected to the sink device.

In an embodiment, the sink device may receive metadata of all multimedia files stored on the source devices connected to the sink device.

In operation S702, the sink device determines whether there is a thumbnail that is not stored in the sink device.

In an embodiment, the sink device may determine whether the sink device stores a multimedia file and whether the sink device stores a thumbnail of the multimedia file based on metadata of the multimedia file received from the source device.

When the sink device determines that there is a thumbnail that is not stored, operation S703 is performed. Alternatively, when the sink device determines that there are no thumbnails that are not stored, operation S708 is performed.

In operation S703, the sink device checks whether the multimedia files are duplicate files.

In an embodiment, the sink device may compare hash values included in the metadata of the multimedia files. The sink device may detect multimedia files corresponding to identical hash values as duplicate files.

In operation S704, the sink device generates a list of source devices that include duplicate files.

In an embodiment, the sink device may generate a duplicate file list. The duplicate file list may list duplicate files, source devices in which duplicate files are stored, and source devices in which thumbnails of duplicate files are stored.

In operation S705, the sink device monitors system resource information of the source devices.

In an embodiment, the sink device may request system resource information from the source devices storing duplicate files. In an embodiment, the sink device may request system resource information from source devices that store thumbnails of duplicate files.

In operation S706, the sink device performs scheduling to obtain thumbnails of duplicate files.

In an embodiment, when a sink device determines to receive thumbnails of duplicate files from source devices, the sink device may schedule how many thumbnails of duplicate files are to be obtained from which source devices. The sink device may determine an allocated number for each of the source devices so as to minimize the time required to receive thumbnails of duplicate files from the source devices.

In an embodiment, when a sink device determines to receive duplicate files from source devices, the sink device may schedule how many duplicate files to obtain from which source devices. The sink device may determine an allocated number for each of the source devices so as to minimize the time required to receive duplicate files from the source devices.

In operation S707, the sink device obtains thumbnails.

In an embodiment, the sink device may obtain thumbnails of duplicate files by requesting thumbnails of an allocated number of duplicate files from each of the source devices and receiving the requested thumbnails in response.

In an embodiment, the sink device may request an allocated number of duplicate files from each of the source devices and receive the requested duplicate files in response. The sink device may obtain thumbnails of duplicate files by generating thumbnails from the received duplicate files.

In an embodiment, the sink device may request an allocated number of duplicate files or thumbnails from each of the source devices in a predetermined order. For example, the predetermined order may be the order in which the sink device displays duplicate files or thumbnails. For example, the predetermined order may be by file name or file size.

In an embodiment, the sink device may store the obtained duplicate files or thumbnails.

In operation S708, the sink device displays thumbnails.

When operation S708 is performed because operation S702 is determined as "Yes", the sink device may display the thumbnails obtained in operation S707. Alternatively, when operation S708 is performed because operation S702 is determined as "No", the sink device may display thumbnails stored in the sink device.

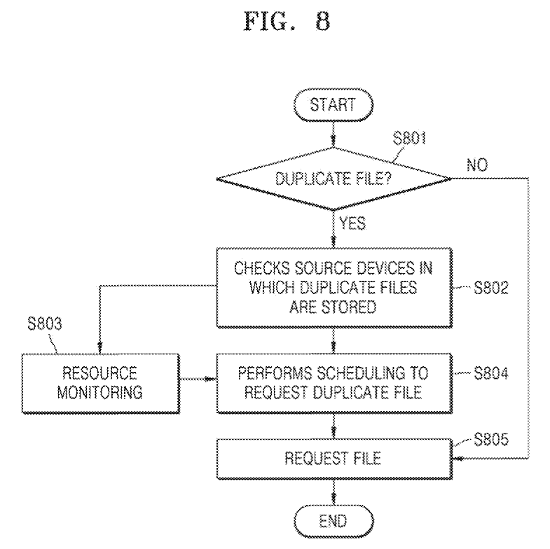

FIG. 8 is a flowchart of a method by which a sink device obtains duplicate files present in source devices, according to an embodiment.

In operation S801, the sink device determines whether a file to be requested from the source devices is a duplicate file.

In an embodiment, in order to request an original file of the thumbnails from the source devices, the sink device may determine whether the original file to be requested from the source devices is a duplicate file.

In an embodiment, the sink device may determine whether an original file to be requested from the source devices is a duplicate file, based on a duplicate file list.

When the sink device determines that the original file being requested is a duplicate file, operation S802 is performed. Alternatively, when the sink device determines that the original file being requested is not a duplicate file, operation S805 is performed.

In operation S802, the sink device checks the source devices in which duplicate files are stored.

In an embodiment, the sink device may identify source devices that store the original file to be requested based on the duplicate file list. The duplicate file list may be pre-generated when the sink device requests thumbnails from source devices.

In operation S803, the sink device monitors system resource information of source devices in which original files, i.e., duplicate files, are stored.

In an embodiment, the sink device may request system resource information from source devices storing duplicate files, and in response, receive system resource information from the source devices.

In operation S804, the sink device performs scheduling to request a duplicate file.

In an embodiment, the sink device may schedule from which source device to obtain duplicate files. The sink device may determine from which source device to obtain duplicate files so as to minimize the time required to receive duplicate files.

In operation S805, the sink device requests a file from the source device.

When operation S805 is performed because operation S801 is determined as "Yes", the sink device may request the original file from the source device determined in operation S804. Alternatively, when operation S805 is performed because operation S801 is determined as "No", the sink device may request the original file from the source device storing the original file.

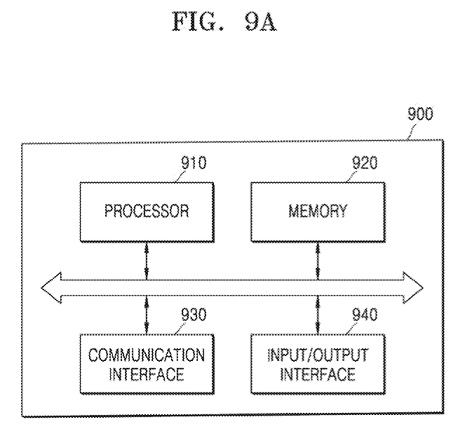

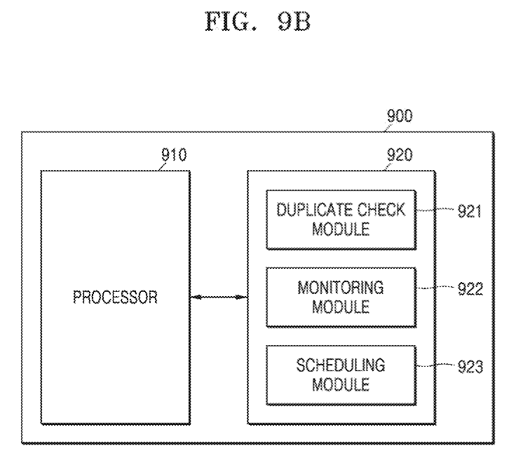

FIG. 9A is a block diagram of a sink device 900 according to an embodiment.

The sink device 900 may include a processor 910, memory 920, a communication interface 930, and an input/output interface 940. The processor 910, the memory 920, the communication interface 930, and the input/output interface 940 may communicate with each other via a bus.

The processor 910 may control the overall operations of the sink device 900. For example, the processor 910 may control the overall operations of the sink device 900 to obtain thumbnails for duplicate files present in the source devices by executing one or more instructions of a program stored in the memory 920. There may be one or more processors 910.

The processor 910 may be configured as at least one of, but is not limited to, a CPU, a microprocessor, a graphic processing unit (GPU), an application specific integrated circuits (ASICs), a digital signal processor (DSPs), a digital signal processing device (DSPDs), a programmable logic device (PLDs), a field programmable gate array (FPGAs), an application processor, a neural processing unit, or an artificial intelligence processor designed with a hardware structure specialized for processing an artificial intelligence model.

The memory 920 may store instructions, data structures, and program codes that may be read by the processor 910. The operations performed by the processor 910 may be implemented by executing instructions or codes of a program stored in the memory 920.

The memory 920 may include a flash memory type, a hard disk type, a multimedia card micro type, a card type memory (e.g., SD or XD memory, etc.), and may include a non-volatile memory including at least one of a ROM (Read-Only Memory), an EEPROM (Electrically Erasable Programmable Read-Only Memory), a PROM (Programmable Read-Only Memory), a magnetic memory, a magnetic disk, or an optical disk, and a volatile memory such as a RAM (Random Access Memory) or an SRAM (Static Random Access Memory).

The memory 920 may store one or more instructions and/or programs that cause the sink device 900 to operate to obtain thumbnails for duplicate files present in the source devices.

The communication interface 930 may perform data communication with other electronic devices under the control of the processor 910.

The communication interface 930 may include a communication circuit that may perform data communication between the sink device 900 and another electronic device by using at least one of data communication methods including, for example, wired LAN, wireless LAN, Wi-Fi, Bluetooth, ZigBee, Wi-Fi Direct (WFD), infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliances (WiGig), or RF communication.

The communication interface 930 may perform data communication with source devices. For example, the communication interface 930 may send a request to source devices and, in response, receive duplicate files, thumbnails, metadata of multimedia files, system resource information, etc. from the source devices.

The input/output interface 940 may include an output unit that provides information or images and an input unit that receives input. The output unit may include a display. The display may display duplicate files or thumbnails. The input unit may receive various types of input from a user, and may include at least one of a touch panel, a keypad, or a pen recognition panel.

FIG. 9B is a block diagram of the sink device 900 according to an embodiment.

In describing FIG. 9B, any details overlapping with those described with reference to FIG. 9A is omitted for brevity.

In an embodiment, the memory 920 may store instructions and/or programs for implementing the functions of a duplicate check module 921, a monitoring module 922, and a scheduling module 923. Additionally, a generation module (not shown) may be stored in the memory 920.

The duplicate check module 921, the monitoring module 922, the scheduling module 923, and the generation module may be executed by the processor 910. Since the descriptions related to the operations of each of the modules described above have already been described in the descriptions of the previous drawings, a repeated description will be omitted.

Embodiments of the present disclosure may also be implemented in the form of a recording medium including computer-executable instructions, such as a program module executed by a computer. Computer-readable media may be any available media that may be accessed by a computer, and include both volatile and nonvolatile media, removable and non-removable media. Also, the computer-readable media may include computer storage media and communication media. The computer storage media includes both volatile and nonvolatile, removable and non-removable media implemented in any method or technology for storage of information such as computer-readable instructions, data structures, program modules or other data. The communication medium may typically include other data in a modulated data signal, such as computer readable instructions, data structures, or program modules.

Also, a computer-readable storage medium may be provided in the form of a non-transitory storage medium. Here, 'non-transitory storage medium' is a tangible device and refers to a device that does not include signals (e.g. electromagnetic waves), and the term does not distinguish between cases where data is stored semi-permanently or temporarily on a storage medium. For example, a 'non-transitory storage medium' may include a buffer in which data is temporarily stored.

According to an embodiment, the method according to various embodiments disclosed in the present document may be provided as included in a computer program product. Computer program products may be traded between sellers and buyers as commodities. The computer program product may be distributed in the form of a machine-readable storage medium (e.g., compact disc read only memory (CD-ROM)), or may be distributed online (e.g., by download or upload) via an application store or directly between two user devices (e.g., smartphones). In the case of online distribution, at least a portion of the computer program product (e.g., a downloadable app) may be at least temporarily stored or temporarily generated in a device-readable storage medium, such as the memory of a manufacturer's server, an application store's server, or an intermediary server.

According to an aspect of the disclosure, a method performed by a sink device for obtaining a plurality of thumbnails corresponding to a plurality of duplicate files stored in a plurality of source devices may be provided. The method may include receiving, from each source device of the plurality of source devices, metadata of multimedia files stored in the source device and system resource information of the source device, detecting, for each source device of the plurality of source devices, the plurality of duplicate files among the multimedia files stored in the source device based on the metadata, determining, for each source device of the plurality of source devices, an allocated number of duplicate files to be requested from the source device based on the system resource information of the source device, and obtaining the plurality of thumbnails by requesting, from each source device of the plurality of source devices, one or more duplicate files of the plurality of duplicate files or one or more thumbnails of the plurality of thumbnails corresponding to the allocated number of duplicate files.

In an embodiment, the determining, for each source device of the plurality of source devices, the allocated number of duplicate files to be requested from the source device may include determining the allocated number for each source device of the plurality of source devices to minimize a time required to receive the plurality of thumbnails corresponding to the plurality of duplicate files from the plurality of source devices.

In an embodiment, the determining, for each source device of the plurality of source devices, the allocated number of duplicate files to be requested from the source device may include estimating, for each source device of the plurality of source devices, a transmission time for transmitting the one or more thumbnails corresponding to the allocated number of duplicate files from the source device to the sink device based on the system resource information of the source device, and determining the allocated number for each source device of the plurality of source devices based on a comparison of the estimated transmission times. A source device with a shorter estimated transmission time may have a larger allocated number than a source device with a longer estimated transmission time.

In an embodiment, the determining, for each source device of the plurality of source devices, the allocated number of the duplicate files to be requested from the source device may include estimating, for each source device of the plurality of source devices, a generation time and a transmission time based on the system resource information of the source device, and determining the allocated number for each source device of the plurality of source devices based on a comparison of sums of the estimated generation time and the estimated transmission time for the plurality of source devices. The generation time may be a time for the source device to generate the one or more thumbnails corresponding to the allocated number of duplicate files, and the transmission time may be a time for the source device to transmit the one or more thumbnails to the sink device. A larger allocated number may be determined for a source device having a smaller sum of the estimated generation time and the estimated transmission time than for a source device having a larger sum of the estimated generation time and the estimated transmission time.

In an embodiment, the obtaining the plurality of thumbnails may include requesting, from each source device of the plurality of source devices, the one or more thumbnails corresponding to the allocated number of the duplicate files, and receiving, from each source device of the plurality of source devices, the one or more thumbnails corresponding to the allocated number of duplicate files determined for the source device.

In an embodiment, the determining, for each source device of the plurality of source devices, the allocated number of duplicate files to be requested from the source device may include determining the allocated number for each source device of the plurality of source devices to minimize a time required to receive the plurality of duplicate files from the source devices.

In an embodiment, the determining, for each source device of the plurality of source devices, the allocated number of duplicate files to be requested from the source device may include estimating, for each of the source devices, a transmission time for transmitting the allocated number of the duplicate files from the source device to the sink device based on the system resource information of the source device, and determining the allocated number for each source device of the plurality of source devices based on a comparison of the estimated transmission times for the plurality of source devices. A larger allocated number may be determined for a source device having a shorter estimated transmission time than for a source device having a longer estimated transmission time.

In an embodiment, the obtaining the plurality of thumbnails may include requesting, from each source device of the plurality of source devices, the one or more duplicate files corresponding to the allocated number, receiving, from each source device of the plurality of source devices, the one or more duplicate files corresponding to the allocated number of duplicate files determined for the source device, and generating the plurality of thumbnails based on the received one or more duplicate files from each source device of the plurality of source devices.

In an embodiment, the obtaining the plurality of thumbnails may be performed based on determining that a first time is shorter than a second time. The first time may include a file receiving time for receiving the one or more duplicate files from the plurality of source devices and a thumbnail generation time for generating the plurality of thumbnails based on the received one or more duplicate files. The second time may include a thumbnail generation time for generating one or more thumbnails at the plurality of source devices and a thumbnail transmission time for transmitting the generated one or more thumbnails from the plurality of source devices to the sink device.

In an embodiment, the method may further include displaying the obtained plurality of thumbnails.

According to an aspect of the disclosure, a sink device for obtaining a plurality of thumbnails corresponding to a plurality of duplicate files stored in a plurality of source devices may be provided. The sink device may include memory storing one or more instructions and one or more processors configured to execute the one or more instructions. The one or more instructions, when executed by the one or more processors individually or collectively, may cause the sink device to receive, from each source device of the plurality of source devices, metadata of multimedia files stored in the source device and system resource information of the source device, detect, for each source device of the plurality of source devices, the plurality of duplicate files among the multimedia files stored in the source device based on the metadata of the multimedia files of the source device, determine, for each source device of the plurality of source devices, an allocated number of the duplicate files to be requested from the source device based on the system resource information of the source device, and obtain the plurality of thumbnails by requesting, from each source device of the plurality of source devices, one or more duplicate files of the plurality of duplicate files or one or more thumbnails of the plurality of thumbnails corresponding to the allocated number of duplicate files.

In an embodiment, the one or more instructions, when executed by the one or more processors, may cause the sink device to determine the allocated number for each source device of the plurality of source devices to minimize a time required to receive the plurality of thumbnails corresponding to the plurality of duplicate files from the plurality of source devices.

In an embodiment, the one or more instructions, when executed by the one or more processors, may cause the sink device to estimate, for each source device of the plurality of source devices, a transmission time for transmitting the one or more thumbnails corresponding to the allocated number of duplicate files from the source device to the sink device based on the system resource information of the source device, and determine the allocated number for each source device of the plurality of source devices based on a comparison of the estimated transmission times. A source device with a shorter estimated transmission time may have a larger allocated number than a source device with a longer estimated transmission time.

In an embodiment, the one or more instructions, when executed by the one or more processors, may cause the sink device to estimate, for each source device of the plurality of source devices, a generation time and a transmission time based on the system resource information of the source device, and determine the allocated number for each source device of the plurality of source devices based on a comparison of sums of the estimated generation time and the estimated transmission time for the plurality of source devices. The generation time may be a time for the source device to generate the one or more thumbnails corresponding to the allocated number of duplicate files, and the transmission time may be a time for the source device to transmit the one or more thumbnails to the sink device. A larger allocated number may be determined for a source device having a smaller sum of the estimated generation time and the estimated transmission time than for a source device having a larger sum of the estimated generation time and the estimated transmission time.

In an embodiment, the one or more instructions, when executed by the one or more processors, may cause the sink device to request, from each source device of the plurality of source devices, the one or more thumbnails corresponding to the allocated number of the duplicate files, and receive, from each source device of the plurality of source devices, the one or more thumbnails corresponding to the allocated number of duplicate files determined for the source device.

In an embodiment, the one or more instructions, when executed by the one or more processors, may cause the sink device to determine the allocated number for each source device of the plurality of source devices to minimize a time required to receive the plurality of duplicate files from the source devices.

In an embodiment, the one or more instructions, when executed by the one or more processors, may cause the sink device to estimate, for each of the source devices, a transmission time for transmitting the allocated number of the duplicate files from the source device to the sink device based on the system resource information of the source device, and determine the allocated number for each source device of the plurality of source devices based on a comparison of the estimated transmission times for the plurality of source devices. A larger allocated number may be determined for a source device having a shorter estimated transmission time than for a source device having a longer estimated transmission time.

In an embodiment, the one or more instructions, when executed by the one or more processors, may cause the sink device to request, from each source device of the plurality of source devices, the one or more duplicate files corresponding to the allocated number, receive, from each source device of the plurality of source devices, the one or more duplicate files corresponding to the allocated number of duplicate files determined for the source device, and generate the plurality of thumbnails based on the received one or more duplicate files from each source device of the plurality of source devices.

In an embodiment, the one or more instructions, when executed by the one or more processors, may cause the sink device to obtain the plurality of thumbnails based on a determination that a first time is shorter than a second time. The first time may include a file receiving time for receiving the one or more duplicate files from the plurality of source devices and a thumbnail generation time for generating the plurality of thumbnails based on the received one or more duplicate files. The second time may include a thumbnail generation time for generating one or more thumbnails at the plurality of source devices and a thumbnail transmission time for transmitting the generated one or more thumbnails from the plurality of source devices to the sink device.

According to an aspect of the disclosure, a non-transitory computer-readable recording medium having recorded thereon a program for causing a sink device to perform the method may be provided.

The description of the present disclosure is for illustrative purposes only, and a person having ordinary skill in the art to which the present disclosure pertains will understand that the present disclosure may be easily modified into other specific forms without changing the technical idea or essential characteristics of the present disclosure. Therefore, it should be understood that the embodiments described above are examples in all respects and not limiting. For example, each component described as a single entity may be implemented in a distributed manner, and likewise, components described as distributed may be implemented in a combined manner.

The scope of the present disclosure is indicated by the claims described below rather than the detailed description above, and all changes or modifications derived from the meaning and scope of the claims and their equivalent concepts should be interpreted as being included in the scope of the present disclosure.

What is claimed is:

1. A method performed by a sink device for obtaining a plurality of thumbnails corresponding to a plurality of duplicate files stored in a plurality of source devices, the method comprising:
receiving, from each source device of the plurality of source devices, metadata of multimedia files stored in the source device and system resource information of the source device;
detecting, for each source device of the plurality of source devices, the plurality of duplicate files among the multimedia files stored in the source device based on the metadata;
determining, for each source device of the plurality of source devices, an allocated number of duplicate files to be requested from the source device based on the system resource information of the source device; and
obtaining the plurality of thumbnails by requesting, from each source device of the plurality of source devices, one or more duplicate files of the plurality of duplicate files or one or more thumbnails of the plurality of thumbnails corresponding to the allocated number of duplicate files.

2. The method of claim 1, wherein the determining, for each source device of the plurality of source devices, the allocated number of duplicate files to be requested from the source device comprises determining the allocated number for each source device of the plurality of source devices to minimize a time required to receive the plurality of thumbnails corresponding to the plurality of duplicate files from the plurality of source devices.

3. The method of claim 1, wherein the determining, for each source device of the plurality of source devices, the allocated number of duplicate files to be requested from the source device comprises:
estimating, for each source device of the plurality of source devices, a transmission time for transmitting the one or more thumbnails corresponding to the allocated number of duplicate files from the source device to the sink device based on the system resource information of the source device; and
determining the allocated number for each source device of the plurality of source devices based on a comparison of the estimated transmission times, wherein a source device with a shorter estimated transmission time has a larger allocated number than a source device with a longer estimated transmission time.

4. The method of claim 1, wherein the determining, for each source device of the plurality of source devices, the allocated number of the duplicate files to be requested from the source device comprises:
estimating, for each source device of the plurality of source devices, a generation time and a transmission time based on the system resource information of the source device, wherein the generation time is a time for the source device to generate the one or more thumbnails corresponding to the allocated number of duplicate files, and the transmission time is a time for the source device to transmit the one or more thumbnails to the sink device; and
determining the allocated number for each source device of the plurality of source devices based on a comparison of sums of the estimated generation time and the estimated transmission time for the plurality of source devices, wherein a larger allocated number is determined for a source device having a smaller sum of the estimated generation time and the estimated transmission time than for a source device having a larger sum of the estimated generation time and the estimated transmission time.

5. The method of claim 1, wherein the obtaining the plurality of thumbnails comprises:
requesting, from each source device of the plurality of source devices, the one or more thumbnails corresponding to the allocated number of the duplicate files; and
receiving, from each source device of the plurality of source devices, the one or more thumbnails corresponding to the allocated number of duplicate files determined for the source device.

6. The method of claim 1, wherein the determining, for each source device of the plurality of source devices, the allocated number of duplicate files to be requested from the source device comprises determining the allocated number for each source device of the plurality of source devices to minimize a time required to receive the plurality of duplicate files from the source devices.

7. The method of claim 6, wherein the determining, for each source device of the plurality of source devices, the allocated number of duplicate files to be requested from the source device comprises:
estimating, for each of the source devices, a transmission time for transmitting the allocated number of the duplicate files from the source device to the sink device based on the system resource information of the source device; and
determining the allocated number for each source device of the plurality of source devices based on a comparison of the estimated transmission times for the plurality of source devices, wherein a larger allocated number is determined for a source device having a shorter estimated transmission time than for a source device having a longer estimated transmission time.

8. The method of claim 6, wherein the obtaining the plurality of thumbnails comprises:
requesting, from each source device of the plurality of source devices, the one or more duplicate files corresponding to the allocated number;
receiving, from each source device of the plurality of source devices, the one or more duplicate files corresponding to the allocated number of duplicate files determined for the source device; and
generating the plurality of thumbnails based on the received one or more duplicate files from each source device of the plurality of source devices.

9. The method of claim 8, wherein the obtaining the plurality of thumbnails is performed based on determining that a first time is shorter than a second time, wherein the first time includes a file receiving time for receiving the one or more duplicate files from the plurality of source devices and a thumbnail generation time for generating the plurality of thumbnails based on the received one or more duplicate files, and
wherein the second time includes a thumbnail generation time for generating one or more thumbnails at the plurality of source devices and a thumbnail transmission time for transmitting the generated one or more thumbnails from the plurality of source devices to the sink device.

10. The method of claim 1, further comprising
displaying the obtained plurality of thumbnails.

11. A sink device for obtaining a plurality of thumbnails corresponding to a plurality of duplicate files stored in a plurality of source devices, the sink device comprising:
memory storing one or more instructions; and
one or more processors configured to execute the one or more instructions,
wherein the one or more instructions, when executed by the one or more processors individually or collectively, cause the sink device to:
receive, from each source device of the plurality of source devices, metadata of multimedia files stored in the source device and system resource information of the source device,
detect, for each source device of the plurality of source devices, the plurality of duplicate files among the multimedia files stored in the source device based on the metadata of the multimedia files of the source device,
determine, for each source device of the plurality of source devices, an allocated number of the duplicate files to be requested from the source device based on the system resource information of the source device, and
obtain the plurality of thumbnails by requesting, from each source device of the plurality of source devices, the one or more duplicate files of the plurality of duplicate files or one or more thumbnails of the plurality of thumbnails corresponding to the allocated number of duplicate files.

12. The sink device of claim 11, wherein the one or more instructions, when executed by the one or more processors, cause the sink device to:
determine the allocated number for each source device of the plurality of source devices to minimize a time required to receive the plurality of thumbnails corresponding to the plurality of duplicate files from the plurality of source devices.

13. The sink device of claim 11, wherein the one or more instructions, when executed by the one or more processors, cause the sink device to:
estimate, for each source device of the plurality of source devices, a transmission time for transmitting the one or more thumbnails corresponding to the allocated number of duplicate files from the source device to the sink device based on the system resource information of the source device, and
determine the allocated number for each source device of the plurality of source devices based on a comparison of the estimated transmission times, wherein a source device with a shorter estimated transmission time has a larger allocated number than a source device with a longer estimated transmission time.

14. The sink device of claim 11, wherein the one or more instructions, when executed by the one or more processors, cause the sink device to:
estimate, for each source device of the plurality of source devices, a generation time and a transmission time based on the system resource information of the source device, wherein the generation time is a time for the source device to generate the one or more thumbnails corresponding to the allocated number of duplicate files, and the transmission time is a time for the source device to transmit the one or more thumbnails to the sink device, and
determine the allocated number for each source device of the plurality of source devices based on a comparison of sums of the estimated generation time and the estimated transmission time for the plurality of source devices, wherein a larger allocated number is determined for a source device having a smaller sum of the estimated generation time and the estimated transmission time than for a source device having a larger sum of the estimated generation time and the estimated transmission time.

15. The sink device of claim 11, wherein the one or more instructions, when executed by the one or more processors, cause the sink device to:
request, from each source device of the plurality of source devices, the one or more thumbnails corresponding to the allocated number of the duplicate files; and
receive, from each source device of the plurality of source devices, the one or more thumbnails corresponding to the allocated number of duplicate files determined for the source device.

16. The sink device of claim 11, wherein the one or more instructions, when executed by the one or more processors, cause the sink device to:
determine the allocated number for each source device of the plurality of source devices to minimize a time required to receive the plurality of duplicate files from the source devices.

17. The sink device of claim 16, wherein the one or more instructions, when executed by the one or more processors, cause the sink device to:
estimate, for each of the source devices, a transmission time for transmitting the allocated number of the duplicate files from the source device to the sink device based on the system resource information of the source device; and
determine the allocated number for each source device of the plurality of source devices based on a comparison of the estimated transmission times for the plurality of source devices, wherein a larger allocated number is determined for a source device having a shorter estimated transmission time than for a source device having a longer estimated transmission time.

18. The sink device of claim 16, wherein the one or more instructions, when executed by the one or more processors, cause the sink device to:
request, from each source device of the plurality of source devices, the one or more duplicate files corresponding to the allocated number;
receive, from each source device of the plurality of source devices, the one or more duplicate files corresponding to the allocated number of duplicate files determined for the source device; and
generate the plurality of thumbnails based on the received one or more duplicate files from each source device of the plurality of source devices.

19. The sink device of claim 18, wherein the one or more instructions, when executed by the one or more processors, cause the sink device to:
obtain the plurality of thumbnails based on a determination that a first time is shorter than a second time,
wherein the first time includes a file receiving time for receiving the one or more duplicate files from the plurality of source devices and a thumbnail generation time for generating the plurality of thumbnails based on the received one or more duplicate files, and
wherein the second time includes a thumbnail generation time for generating one or more thumbnails at the plurality of source devices and a thumbnail transmission time for transmitting the generated one or more thumbnails from the plurality of source devices to the sink device.

20. A non-transitory computer-readable recording medium having recorded thereon a program for causing the sink device to perform the method of claim 1.
